(19) United States
(12) Patent Application Publication
(10) Pub. No.: US 2023/0360291 A1
(43) Pub. Date: Nov. 9, 2023

(54) SYSTEM AND METHOD FOR IMPLEMENTING AN INTERACTIVE OUTLINE MODE FOR A GRAPHIC DESIGN INTERFACE

(71) Applicant: Figma, Inc., San Francissco, CA (US)

(72) Inventors: Lauren Budorick, San Francisco, CA (US); Thomas Lowry, San Francisco, CA (US); Heather Tompkins, San Francisco, CA (US); Marcin Wichary, San Francisco, CA (US)

(21) Appl. No.: 18/144,154

(22) Filed: May 5, 2023

Related U.S. Application Data
(60) Provisional application No. 63/339,864, filed on May 9, 2022.

(51) Int. Cl. G06T 11/20

(52) U.S. Cl. CPC G06T 11/203; G06T 2210/12; G06T 2200/24

(57) ABSTRACT

Examples include a computer system and process for rendering a design interface in at least a default mode and in an outline mode. In the default mode, the design interface is rendered to include multiple objects that partially intersect one another in position, so as to form a combined shape. In the outline mode, the design interface is rendered, with each of the multiple objects and combined shape being depicted in outline form.

### RELATED APPLICATIONS

This application claims benefit of priority to Provisional U.S. Patent Application No. 63/339,864, filed May 9, 2022; the aforementioned priority application being hereby incorporated by reference in its entirety.

### TECHNICAL FIELD

Examples described herein relate to a system and method for implementing an interactive outline a graphic design interface.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

### BRIEF DESCRIPTION OF THE DRAWINGS

FIG. 1A illustrates an interactive graphic design system for a computing device of a user, according to one or more examples.

FIG. 1B illustrates a network computing system to implement an interactive graphic design system on a user computing device, according to one or more examples.

FIG. 1C illustrates a network computing system to implement an interactive graphic design system for multiple users in a collaborative network platform, according to one or more examples.

FIG. 2 illustrates a method for implementing an outline mode on a graphic application, according to one or more embodiments.

FIG. 3A and FIG. 3B illustrate an example in which a design interface is rendered by rendering engine toggling between the default mode and the outline mode, according to one or more embodiments.

FIG. 3C illustrates another implementation of the rendering engine 120 implementing the outline mode, according to one or more embodiments.

FIG. 3D through FIG. 3E illustrate another implementation of a design interface that is rendered in default and outline modes, according to one or more embodiments.

FIG. 3F illustrates a variation of a design interface that is rendered in the outline mode, according to one or more embodiments.

FIG. 3G and FIG. 3H illustrate another implementation of a design interface that is rendered in default and outline modes, according to one or more embodiments.

FIG. 3I and FIG. 3J illustrate another implementation of a design interface that is rendered in default and outline modes, according to one or more embodiments.

FIG. 3K illustrates additional functionality that can be provided with a design interface as rendered in the default mode, according to one or more embodiments.

FIG. 4 illustrates a network computer system on which one or more embodiments can be implemented.

FIG. 5 illustrates a user computing device for use with one or more examples, as described.

### DETAILED DESCRIPTION

Embodiments include a computer system on which an interactive graphic design application is provided, where the computer system implements an outline mode to enable a user to view and edit objects of a design interface in an outline form (e.g., wireframe). Among other advantages, embodiments recognize that interactive designs often combine objects (e.g., shapes, containers, etc.) in a manner where objects become occluded or difficult to visualize. Further, under conventional approaches, designers often have to take additional steps to access and edit an occluded object. For example, designers may have to select a particular layer where the object of interest lies, or temporarily reposition an occluded object to edit it. These approaches remove the object from the context. In contrast, embodiments as described enable the designer to view a design in an outline mode, where all objects that are present on the canvas are viewable as outline shapes (e.g., wireframes). In this mode, the designer is able to view spatial attributes of occluded or non-visible object, such as placement and alignment. Further, in the outline mode, the designer is able to view occluded objects directly, without taking additional steps such as selecting layers or removing overlaying objects.

Examples further include a computer system and process for rendering a design interface in at least a default mode and in an outline mode. In the default mode, the design interface is rendered to include multiple objects that partially intersect one another in position, so as to form a combined shape. In the outline mode, the design interface is rendered, with each of the multiple objects and combined shape being depicted in outline form.

In examples, rendering the design interface includes applying multiple possible logic types, including Boolean type combination logic. Further, the Boolean type combination logic can include union combination, intersection combination, subtraction combination, or exclude combination type logic. In examples, the user can select the logic type from multiple possible logic types, in order to form the combined shape, where the combined shape is based at least in part on the selected logic type.

Additional examples include a computer system and process where a rendering engine is implemented, where the rendering engine can be operated in at least a default mode and an outline mode. In the default mode, the rendering engine is operable to render a design interface that includes multiple objects, and to apply occlusive logic to (i) occlude at least a portion of an object that intersects another object, and (ii) preclude a type of user interaction with the portion of the object that is occluded. In the outline mode, the rendering engine is operable to render an outline of each of the multiple objects without occlusion, and to enable the type of user interaction with the portion of the object that is occluded in the default mode.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

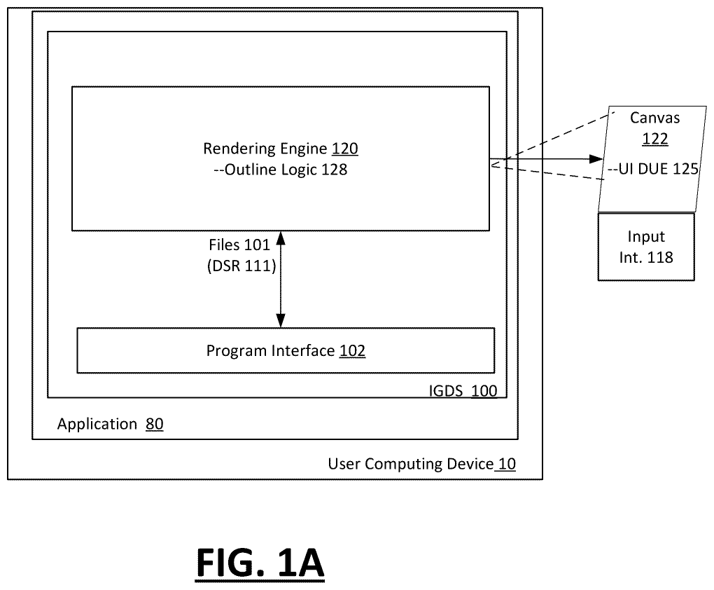

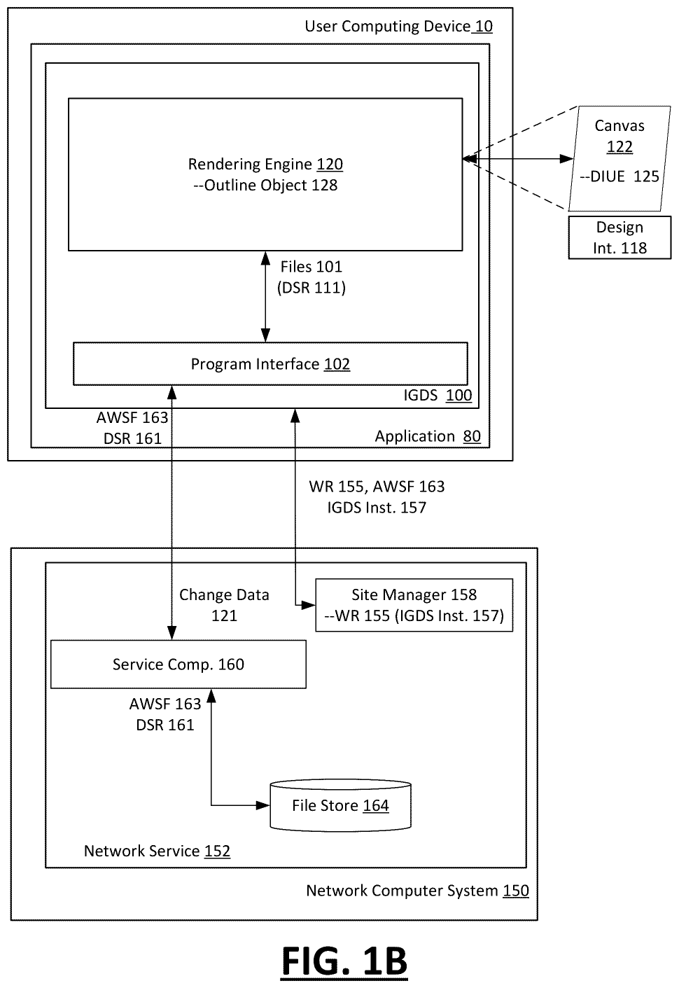

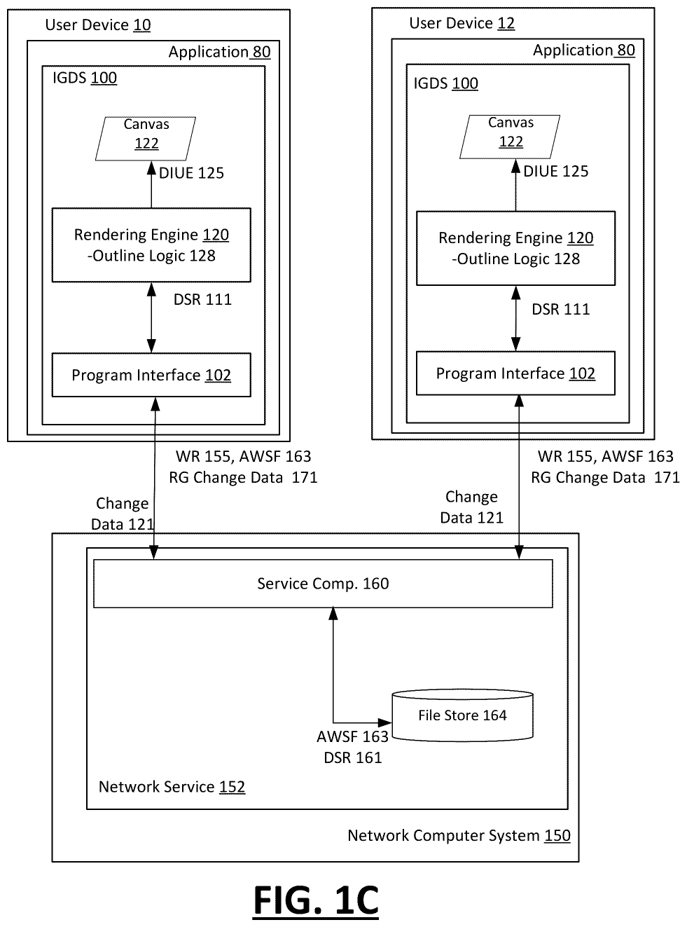

FIG. 1A illustrates an interactive graphic design system for a computing device of a user, according to one or more examples. An interactive graphic design system (“IGDS”) 100 can be implemented in any one of multiple different computing environments. For example, in some variations, the IGDS 100 can be implemented as a client-side application that executes on the user computing device 10 to provide functionality as described with various examples. In other examples, such as described below, the IGDS 100 can be implemented through use of a web-based application 80. As an addition or alternative, the IGDS 100 can be implemented as a distributed system, such that processes described with various examples execute on a network computer (e.g., server) and on the user device 10.

According to examples, the IGDS 100 can be implemented on a user computing device 10 to enable a corresponding user to design various types of interfaces using graphical elements. The IGDS 100 can include processes that execute as or through a web-based application 80 that is installed on the computing device 10. As described by various examples, web-based application 80 can execute scripts, code and/or other logic (the “programmatic components”) to implement functionality of the IGDS 100. Additionally, in some variations, the IGDS 100 can be implemented as part of a network service, where web-based application 80 communicates with one or more remote computers (e.g., server used for a network service) to executes processes of the IGDS 100.

In some examples, web-based application 80 retrieves some or all of the programmatic resources for implementing the IGDS 100 from a network site. As an addition or alternative, web-based application 80 can retrieve some or all of the programmatic resources from a local source (e.g., local memory residing with the computing device 10). The web-based application 80 may also access various types of data sets in providing the IGDS 100. The data sets can correspond to files and libraries, which can be stored remotely (e.g., on a server, in association with an account) or locally.

In examples, the web-based application 80 can correspond to a commercially available browser, such as GOOGLE CHROME (developed by GOOGLE, INC.), SAFARI (developed by APPLE, INC.), and INTERNET EXPLORER (developed by the MICROSOFT CORPORATION). In such examples, the processes of the IGDS 100 can be implemented as scripts and/or other embedded code which web-based application 80 downloads from a network site. For example, the web-based application 80 can execute code that is embedded within a webpage to implement processes of the IGDS 100. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

According to examples, user of computing device 10 operates web-based application 80 to access a network site, where programmatic resources are retrieved and executed to implement the IGDS 100. In this way, the user may initiate a session to implement the IGDS 100 for purpose of creating and/or editing a design interface. In examples, the IGDS 100 includes a program interface 102, an input interface 118, and a rendering engine 120. The program interface 102 can include one or more processes which execute to access and retrieve programmatic resources from local and/or remote sources.

In an implementation, the program interface 102 can generate, for example, a canvas 122, using programmatic resources which are associated with web-based application 80 (e.g., HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 may also retrieve programmatic resources that include an application framework for use with canvas 122. The application framework can include data sets which define or configure, for example, a set of interactive graphic tools that integrate with the canvas 122 and which comprise the input interface 118, to enable the user to provide input for creating and/or editing a design interface.

According to some examples, the input interface 118 can be implemented as a functional layer that is integrated with the canvas 122 to detect and interpret user input. The input interface 118 can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location of input), as well as inputs to define attributes (e.g., dimensions) of a selected shape. In examples, some portions of the input interface 118 can be selectively or intermittingly integrated with the canvas 122, to allow the user to perform certain actions without being distracted from the canvas 122.

In some examples, the input interface 118 can enable the user to select settings and modes of operations. As described with some examples, the input interface 118 can include a mode-switch feature to enable the user to switch between rendering modes, such as between a default mode and an outline mode.

Additionally, the program interface 102 can be used to retrieve, from local or remote sources, programmatic resources and data sets which include files 101 which comprise an active workspace for the user. The retrieved data sets can include one or more pages that include design elements which collectively form a design interface, or a design interface that is in progress. Each file 101 can include one or multiple data structure representations 111 which collectively define the design interface. The files 101 may also include additional data sets which are associated with the active workspace. For example, as described with some examples, the workspace file can store animation data sets which define animation behavior as between objects or states in renderings of the canvas 122.

In examples, the rendering engine 120 uses the data structure representations 111 to render a corresponding DIUE 125 on the canvas 122, wherein the DIUE 125 reflects graphic elements and their respective attributes as provided with the individual pages of the files 101. The user can edit the DIUE 125 using the input interface 118. Alternatively, the rendering engine 120 can generate a blank page for the canvas 122, and the user can use the input interface 118 to generate the DIUE 125. As rendered, the DIUE 125 can include graphic elements such as a background and/or a set of objects (e.g., shapes, text, images, programmatic elements), as well as attributes of the individual graphic elements. Each attribute of a graphic element can include an attribute type and an attribute value. For an object, the types of attributes include, shape, dimension (or size), layer, type, color, line thickness, text size, text color, font, and/or other visual characteristics. Depending on implementation, the attributes reflect properties of two- or three-dimensional designs. In this way, attribute values of individual objects can define, for example, visual characteristics of size, color, positioning, layering, and content, for elements that are rendered as part of the DIUE 125.

In examples, rendering engine 120 can implement alternative sets of rendering logic that affect the manner in which objects of design interface are rendered. The alternative sets of rendering logic can include programs, functions, formulas or other configurations which the user can select to implement through the rendering engine 120. Based on implementation, the alternative sets of rendering logic can be made available for use with the rendering engine 120 as a plug-in program or user selectable setting.

In some examples, the rendering engine 120 can implement occlusive logic, where objects or portions thereof are hidden by application of logic (e.g., a setting, functionality, program, etc.). In examples, the occlusive logic includes overlay logic (e.g., where one object is positioned over another object, such that the underlying object is hidden). As an addition or alternative, the occlusive logic can include object combination logic, which can be implemented in connection with multiple objects that overlap on the canvas 122. In some examples, the object combination logic can implement any one of multiple possible Boolean relationships that governs how the intersection of the two objects are to be rendered. For example, the Boolean object combination logic can include union combination, intersection combination, subtraction combination, or exclude combination.

Still further, the occlusive logic can include clip logic, where portions of an object that extend beyond a boundary of a container object are hidden. As another example, the occlusive logic can include hidden logic that provides for one object to be hidden in whole or in part on the canvas 122.

Network Computing System to Implement IGDS

FIG. 1B illustrates a network computing system to implement an interactive graphic design system on a user computing device, according to one or more examples. A network computing system such as described with an example of FIG. 1B can be implemented using one or more servers which communicate with user computing devices over one or more networks.

In an example of FIG. 1B, the network computing system 150 perform operations to enable the IGDS 100 to be implemented on the user computing device 10. In variations, the network computing system 150 provides a network service 152 to support the use of the IGDS 100 by user computing devices that utilize browsers or other web-based applications. The network computing system 150 can include a site manager 158 to manage a website where a set of web-resources 155 (e.g., web page) are made available for site visitors. The web-resources 155 can include instructions, such as scripts or other logic (“IGDS instructions 157”), which are executable by browsers or web components of user computing devices.

In some variations, once the computing device 10 accesses and downloads the web-resources 155, web-based application 80 executes the IGDS instructions 157 to implement functionality such as described with some examples of FIG. 1A. For example, the IGDS instructions 157 can be executed by web-based application 80 to initiate the program interface 102 on the user computing device 10. The initiation of the program interface 102 may coincide with the establishment of, for example, a web-socket connection between the program interface 102 and a service component 160 of the network computing system 150.

In some examples, the web-resources 155 includes logic which web-based application 80 executes to initiate one or more processes of the program interface 102, causing the IGDS 100 to retrieve additional programmatic resources and data sets for implementing functionality as described by examples. The web resources 155 can, for example, embed logic (e.g., JAVASCRIPT code), including GPU accelerated logic, in an HTLM page for download by computing devices of users. The program interface 102 can be triggered to retrieve additional programmatic resources and data sets from, for example, the network service 152, and/or from local resources of the computing device 10, in order to implement the IGDS 100. For example, some of the components of the IGDS 100 can be implemented through web-pages that can be downloaded onto the computing device 10 after authentication is performed, and/or once the user performs additional actions (e.g., download one or more pages of the workspace associated with the account identifier). Accordingly, in examples as described, the network computing system 150 can communicate the IGDS instructions 157 to the computing device 10 through a combination of network communications, including through downloading activity of web-based application 80, where the IGDS instructions 157 are received and executed by web-based application 80.

The computing device 10 can use web-based application 80 to access a website of the network service 152 to download the webpage or web resource. Upon accessing the website, web-based application 80 can automatically (e.g., through saved credentials) or through manual input, communicate an account identifier to the service component 160. In some examples, web-based application 80 can also communicate one or more additional identifiers that correlate to a user identifier.

Additionally, in some examples, the service component 160 can use the user or account identifier of the user identifier to retrieve profile information 109 from a user profile store. As an addition or variation, profile information 109 for the user can be determined and stored locally on the user's computing device 10.

The service component 160 can also retrieve the files of an active workspace (“active workspace files 163”) that are linked to the user account or identifier from a file store 164. The profile store can also identify the workspace that is identified with the account and/or user, and the file store 164 can store the data sets that comprise the workspace. The data sets stored with the file store 164 can include, for example, the pages of a workspace, data sets that identify constraints for an active set of workspace files, and one or more data structure representations 161 for the design under edit which is renderable from the respective active workspace files.

Additionally, in examples, the service component 160 provides a representation of the workspace associated with the user to the web-based application 80, where the representation identifies, for examples, individual files associated with the user and/or user account. The workspace representation can also identify a set of files, where each file includes one or multiple pages, and each page including objects that are part of a design interface.

On the user device 10, the user can view the workspace representation through web-based application 80, and the user can elect to open a file of the workspace through web-based application 80. In examples, upon the user electing to open one of the active workspace files 163, web-based application 80 initiates the canvas 122. For example, the IGDS 100 can initiate an HTML 5.0 canvas as a component of web-based application 80, and the rendering engine 120 can access one or more data structures representations 111 of a design interface under edit, to render the corresponding DIUE 125 on the canvas 122.

The service component 160 may also determine, based on the user credentials, a permission setting or role of the user in connection with the account identifier. The permission settings or role of the user can determine, for example, the files which can be accessed by the user. In some examples, the implementation of the rendering engine 120 on the computing device 10 can be configured based at least in part on the role or setting of the user.

In examples, the changes implemented by the rendering engine 120 to the DIUE 125 can also be recorded with the respective data structure representations 111, as stored on the computing device 10. The program interface 102 can repeatedly, or continuously stream change data 121 to the service component 160, wherein the updates reflect edits as they are made to the DIUE 125 and to the data structure representation 111 to reflect changes made by the user to the DIUE 125 and to the local data structure representations 111 of the DIUE 125. The service component 160 can receive the change data 121, which in turn can be used to implement changes to the network-side data structure representations 161. In this way, the network-side data structure representations 161 for the active workspace files 163 can mirror (or be synchronized with) the local data structure representations 111 on the user computing device 10. When the rendering engine 120 implements changes to the DIUE 125 on the user device 10, the changes can be recorded or otherwise implemented with the local data structure representations 111, and the program interface 102 can stream the changes as change data 121 to the service component 160 in order to synchronize the local and network-side representations 111, 161 of the DIUE 125. This process can be performed repeatedly or continuously, so that the local and network-side representations 111, 161 of the DIUE 125 remain synchronized.

Collaborative Network Platform

FIG. 1C illustrates a network computing system to implement an interactive graphic design system for multiple users in a collaborative network platform, according to one or more examples. In an example of FIG. 1C, a collaborative network platform is implemented by the network computing system 150, which communicates with multiple user computing devices 10, 12 over one or more networks (e.g., World Wide Web) to implement the IGDS 100 on each computing device. While FIG. 1C illustrates an example in which two users utilize the collaborative network platform, examples as described allow for the network computing system 150 to enable collaboration on design interfaces amongst a larger group of users.

With respect to FIG. 1C, the user computing devices 10, 12 can be assumed as being operated by users that are associated with a common account, with each user computing device 10, 12 implementing a corresponding IGDS 100 to access the same workspace during respective sessions that overlap with one another. Accordingly, each of the user computing devices 10, 12 may access the same set of active workspace files 163 at the same time, with the respective program interface 102 of the IGDS 100 on each user computing device 10, 12 operating to establish a corresponding communication channel (e.g., web socket connection) with the service component 160.

In examples, the service component 160 can communicate a copy of the active workspace files 163 to each user computing device 10, 12, such that the computing devices 10, 12 render the DIUE 125 of the active workspace files 163 at the same time. Additionally, each of the computing devices 10, 12 can maintain a local data structure representation 111 of the respective DIUE 125, as determined from the active workspace files 163. The service component 160 can also maintain a network-side data structure representation 161 obtained from the files of the active workspace 163, and coinciding with the local data structure representations 111 on each of the computing devices 10, 12.

The network computing system 150 can continuously synchronize the active workspace files 163 on each of the user computing devices. In particular, changes made by users to the DIUE 125 on one computing device 10, 12 may be immediately reflected on the DIUE 125 rendered on the other user computing device 10, 12. By way of example, the user of computing devices 10 can make a change to the respective DIUE 125, and the respective rendering engine 120 can implement an update that is reflected in the local copy of the data structure representation 111. From the computing device 10, the program interface 102 of the IGDS 100 can stream change data 121, reflecting the change of the user input, to the service component 160. The service component 160 processes the change data 121 of the user computing device. The service component 160 can use the change data 121 to make a corresponding change to the network-side data structure representation 161. The service component 160 can also stream remotely-generated change data 171 (which in the example provided, corresponds or reflects change data 121 received from the user device 10) to the computing device 12, to cause the corresponding IGDS 100 to update the DIUE 125 as rendered on that device. The computing device 12 may also use the remotely generated change data 171 to update with the local data structure representation 111 of that computing device 12. The program interface 102 of the computing device 12 can receive the update from the network computing system 150, and the rendering engine 120 can update the DIUE 125 and the respective local copy of 111 of the computing device 12.

The reverse process can also be implemented to update the data structure representations 161 of the network computing system 150 using change data 121 communicated from the second computing device 12 (e.g., corresponding to the user of the second computing device updating the DIUE 125 as rendered on the second computing device 12). In turn, the network computing system 150 can stream remotely generated change data 171 (which in the example provided, corresponds or reflects change data 121 received from the user device 12) to update the local data structure representation 111 of the DIUE 125 on the first computing device 10. In this way, the DIUE 125 of the first computing device 10 can be updated as a response to the user of the second computing device 12 providing user input to change the DIUE 125.

To facilitate the synchronization of the data structure representations 111, 111 on the computing devices 10, 12, the network computing system 150 may implement a stream connector to merge the data streams which are exchanged between the first computing device 10 and the network computing system 150, and between the second computing device 12 and the network computing system 150. In some implementations, the stream connector can be implemented to enable each computing device 10, 12 to make changes to the network-side data representation 161, without added data replication that may otherwise be required to process the streams from each device separately.

Additionally, over time, one or both of the computing devices 10, 12 may become out-of-sync with the server-side data representation 161. In such cases, the respective computing device 10, 12 can redownload the active workspace files 163, to restart the maintenance of the data structure representation of the DIUE 125 that is rendered and edited on that device.

Outline Mode

With reference to examples such as described with FIG. 1A through FIG. 1C, the rendering engine 120 implements outline logic 128 to render a design interface in an outline mode. A user can toggle the rendering engine 120 between a default mode and the outline mode. In a default mode, objects rendered on the canvas have fills (e.g., colors, patterns, etc.) and other interior attributes. In the outline mode, the rendering engine 120 renders objects as wireframes. As such, the multiple objects may lack, for example, interior fill attributes (e.g., color or pattern fill within the wireframe). Depending on implementation, in the outline mode, objects can be rendered with one or multiple line attributes. In variations, the multiple objects may be rendered with different line attributes that those which are provided in the default mode. In some variations, the rendering engine 120 renders objects as frames, with each object having the line stroke characteristic provided with the object in the default mode. Still further, in other variations, the rendering engine 120 renders objects as frames, with line frame attributes being determined based on a particular type of rendering logic associated with the object. For example, the line frame attribute of a combined shape can be determined by the Boolean object combination logic used to form the combined shape.

Additionally, in some examples, the rendering engine 120 can operate in the outline mode to enable a user to access and edit an object that is overlaid by another object. In the default mode, the rendering engine 120 may occlude the overlaid object, and the overlaid object is not accessible for manipulation by the user while it is overlaid. In such cases, the user may have to take additional measures, such as select a particular layer of the occluded object move the front object backwards in the layer of the design interface, or spatially separate the two objects so that each can be edited. In contrast, under embodiments as described, the user can toggle the rendering engine 120 into the outline mode, in order to concurrently view both the front and back (or overlaid) object at the same time, and further to access and edit the back object. In this way, the rendering engine 120 enables the user to manipulate an object that is behind another object, when that object would otherwise be occluded and inaccessible in the default mode.

Further, in examples, the rendering engine 120 can display bounding boxes for individual objects. A bounding box may be specific to an object, and provided as a feature to enable the user to view attributes of the bound object, as well as to manipulate the object (e.g., resize object, reposition object, align object with another object, etc.). The bounding box can provide information about the object on the canvas, such as, for example, the coordinates of the center of the object, dimensions of the object, centerline and other references of the object, and alignment of the object with other objects. The bounding box can also include features that can receive particular types of input to change the properties of the object. For example, the bounding box can include handles that can receive input (e.g., click and drag) to change one or two dimensions of the object.

According to some examples, when in the outline mode, the rendering engine 120 can be operated to render bound outlines of individual objects. Thus, an object that is occluded or otherwise overlaid by another object in the default mode appears as a bound object in the outline mode, and the user can interact with the boundary box to view information about the object and/or manipulate the object.

Methodology

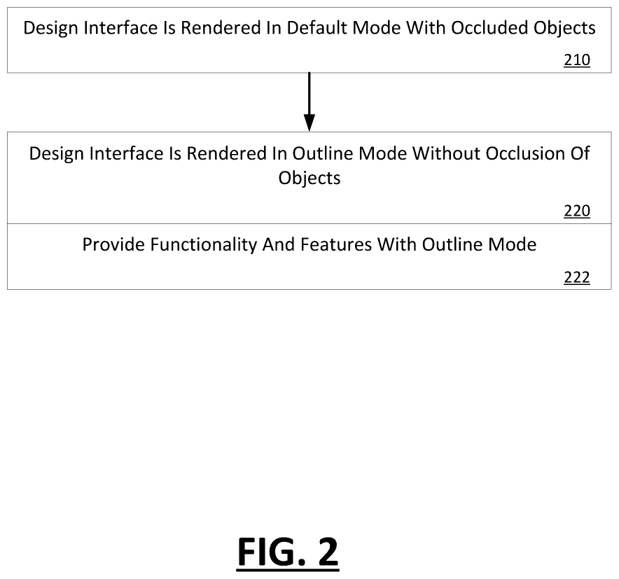

FIG. 2 illustrates a method for implementing an outline mode on a graphic application, according to one or more embodiments. A method such as described by an example of FIG. 2 may be implemented on a user computing device that implements an interactive graphic design application. Accordingly, reference may be made to elements of FIG. 1A through FIG. 1C for purpose of illustrating suitable components for performing a step or sub-step being described.

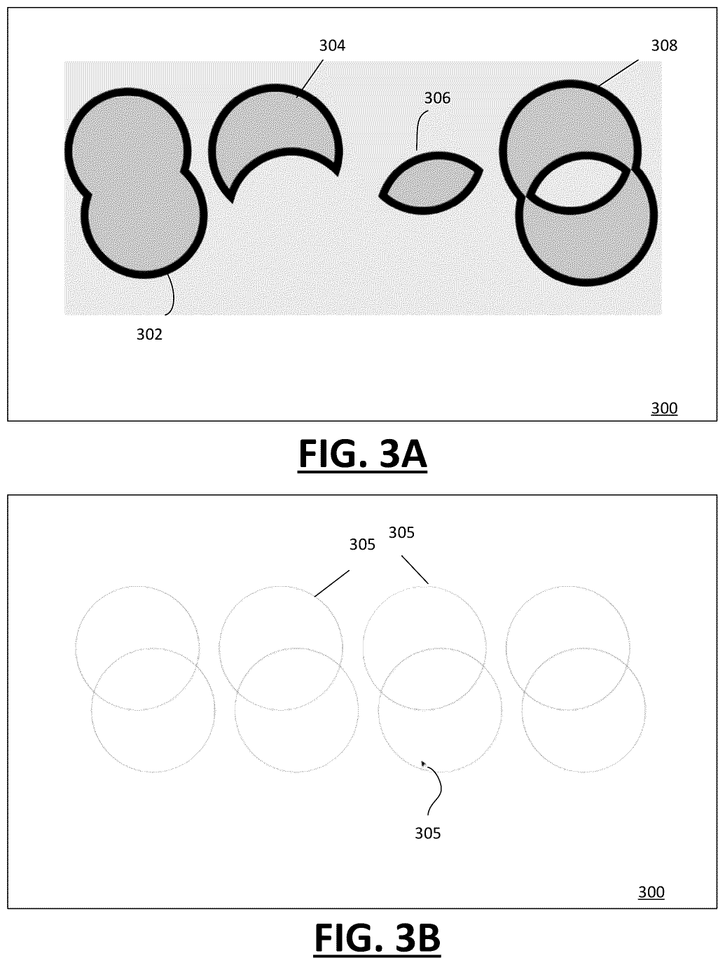

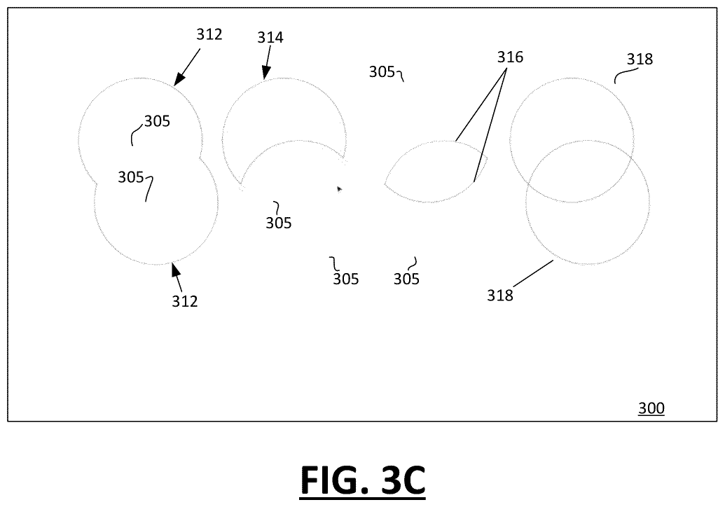

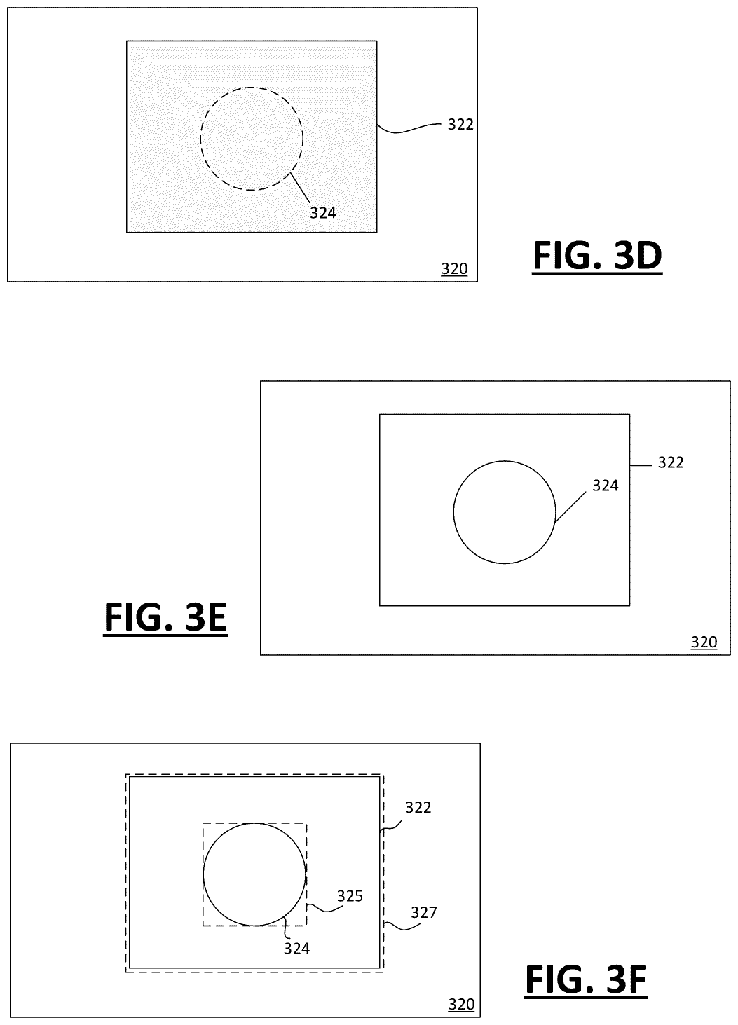

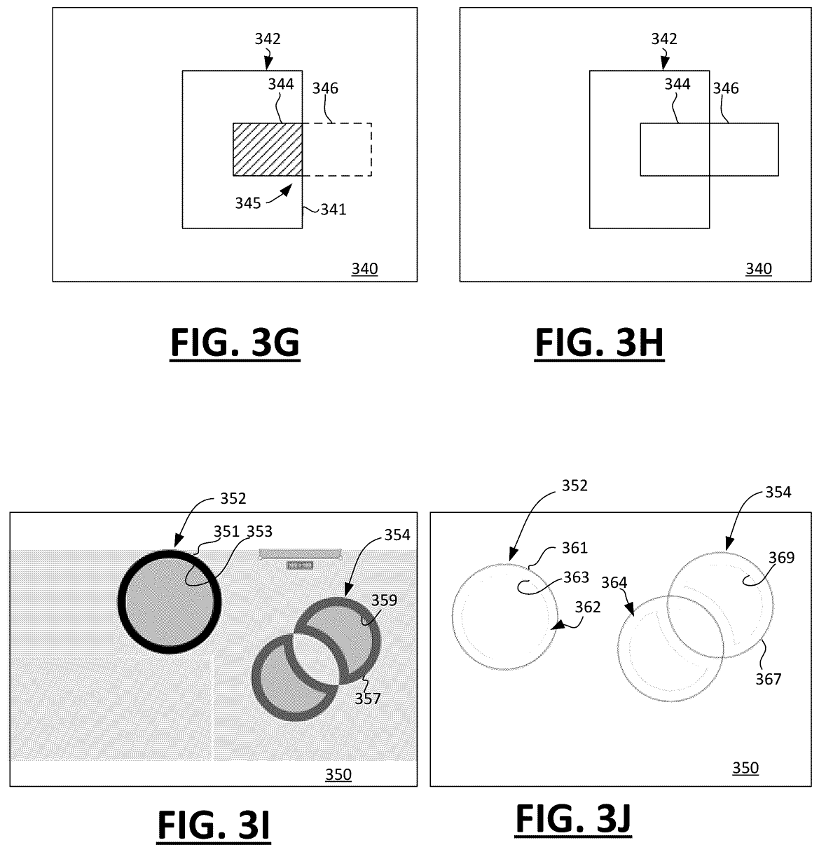

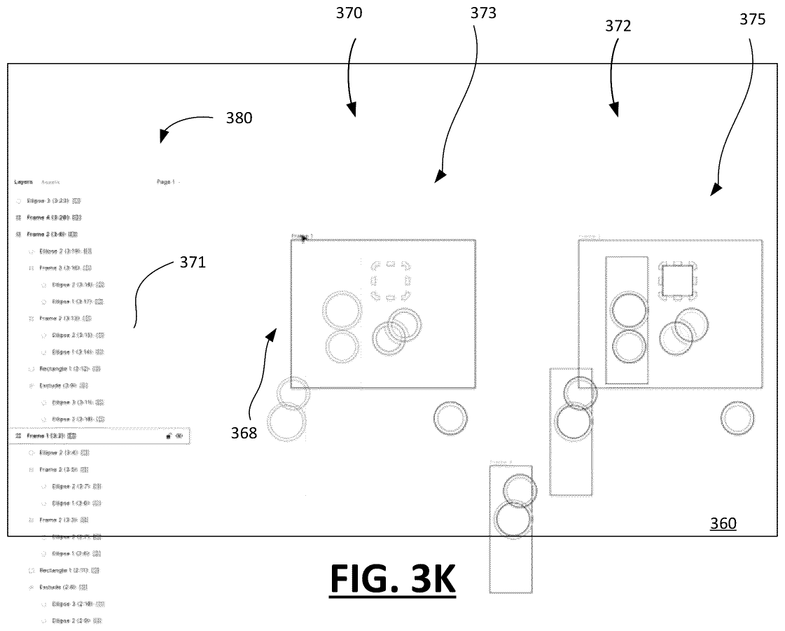

With reference to FIG. 2, IGDS 100 is operated in a default mode, where the design interface includes occluded objects (210). As described with examples, the rendering engine 120 of IGDS 100 can implement the alternative default and outline modes. In the default mode, the rendering engine 120 can display a design interface having objects that include fill and line attributes. The rendering engine 120 can further implement any one of multiple types of occlusion logic to hide objects or portions thereof in the course of users editing a design interface where objects are overlaid, combined, layered or otherwise designated to be made hidden. The type and manner in which occlusion logic may be used can be based on design input and choices made by a user. In examples, the occlusion logic can include (i) overlay logic, where a front object overlays a back object, and the back object is hidden as a result of its position relative to the front object (e.g., see FIG. 3D); (ii) object combination logic, including Boolean type object combination logic (e.g., see FIG. 3A), where a portion of one or more objects that are combined are hidden; (iii) clip logic, where a portion of an object that extends outside of a container object is hidden or clipped from view (e.g., see FIG. 3G); and/or (iv) hidden designation logic, where individual objects on the canvas are selected by the user to be hidden. The rendering engine 120 can apply different types of occlusion logic (such as may be selected by the user) when rendering the design interface.

The IGDS can be operated in the outline mode, where the rendering engine 120 renders the objects of the design interface in an outline form, without occlusion (220). Thus, all objects that are present on the design interface are rendered in the outline form without any object or portion thereof being hidden.

Further, when the IGDS 100 is operated in the outline mode, the rendering engine 120 can implement functionality for enabling user interaction with objects that is not available with the default mode (222). In examples, objects which are hidden in the default mode are accessible to the user in the outline mode. For example, users can directly interact with the outline forms of any object that appears on the canvas 122, including objects that were hidden in the default mode. Thus, for example, if an object is overlaid on (or in front of) another object, the outline form of the underlying object (or object that is behind the front object) can receive user input that changes one or more attributes of that object. For example, the underlying object can be re-sized, repositioned, or have other attributes altered, without the user having to take additional steps to access the underlying object, as would otherwise be required in the default mode.

As another example, when a design interface is rendered in the outline mode, the user can interact with the outline form of a container objects to view all objects that are partially contained within the container. Still further, collections of objects can be represented in a hierarchical nodal form, such that selection of one node (e.g., container object) identifies all nodes that are part of the subtree of the selected node (e.g., objects contained or partially contained by the container object). For example, the user can hover or select the outline form of a container object on the design interface, in order to highlight the outline forms of other objects that are part of the container object or the subtree of the node of the container object.

### Examples

FIG. 3A and FIG. 3B illustrate an example design interface that is provided by a rendering engine being toggled between a default mode and an outline mode, according to one or more embodiments. In FIG. 3A, the design interface 300 is shown in the default mode, where shapes 302, 304, 306, 308 are rendered with fill and interior attributes. As shown, each of the combined shapes 302, 304, 306, 308 as rendered in the default mode is formed by combining a similar or identical pair of circular objects using a respective Boolean object combination logic. The combined shape 302 is formed by applying union combination logic to the pair of overlapping circular objects. As a result, an outer boundary of the combined shape consist of the composite of the constituent objects, less any segments that overlap. As such, the union combination logic is also an example of occlusive logic.

Further, the combined shape 304 is formed by applying subtract combination logic to the pair of overlapping circular objects. The subtract combination logic is another example of occlusive logic, and application of the subtract combination logic results in removal of an area that is attributable to one of the pair of objects (e.g., the front object).

The combined shape 306 is formed by applying intersection combination logic to the pair of overlapping circular objects. The intersection combination logic consists of the overlapping portions of the pair of circular objects. As such, the intersection combination logic is also an example of occlusive logic.

Further, the combined shape 308 is formed by applying exclude combination logic to the pair of overlapping circular objects. The exclude combination logic shows only the portions of the pair of circular objects that do not overlap, with the overlapping portion being rendered as a void. In this wat, exclude combination logic provides another example of occlusion logic.

FIG. 3B illustrates the design interface 300, as rendered in the outline mode. In the outline mode, the outline forms of the pairs of circular objects 305 that form the combined shapes is shown. The different object combination logic and/or occlusive logic which is used to form the combined shapes 302, 304, 306, 308 do not affect rendering of the constituent pairs of objects that form the combined shape in outline form. Thus, the user is able to view the outline forms each object 305 that forms one of the combined shapes 302, 304, 306, 308 without any occlusive effect that would otherwise hide a portion of the object from view in the default mode. As such, each of the constituent objects 305 that forms one of the combined shapes 302, 304, 306, 308, can be directly accessed and edited by a user, without need to reposition the objects to remove occlusive effects of other objects.

FIG. 3C illustrates an alternative implementation of an outline mode of the design interface shown in FIG. 3A, according to one or more embodiments. FIG. 3C illustrates an implementation in which the outline forms 312, 314, 316, 318 of objects 305 rendered on the canvas 122 have different attributes. For example, the outline forms 312, 314, 316, 318 can have different attributes of line thickness, line type, line color, corner or end attributes (e.g., clipped corners, rounded ends, etc.), and other attributes. Still further, the attributes of the outline forms 312, 314, 316, 318 can have attributes of multiple lines, such as interior lines, line fill or pattern, and exterior lines. An example shown by FIG. 3C can be implemented by, for example, the user making a setting selection for the operation of the rendering engine 120. In some examples, a user can operate the IGDS 100 to view the design interface 300 in the default mode (see FIG. 3A), select to view the design interface 300 in outline mode (see FIG. 3B), and apply a setting to view the design interface 300 in an alternative implementation shown by FIG. 3C.

In FIG. 3C, the outline forms 312, 314, 316, 318 are shown for the respective combined shapes 302, 304, 306, 308. In addition, the outline forms 312, 314, 316, 318 can be combined with outlines of the constituent objects 305. Further, the line characteristic of the outline forms 312, 314, 316, 318 for the combined shapes may be different than the outlines for the respective constituent objects 305. For example, the line characteristic of the outline forms 312, 314, 316, 318 can vary from the outline of the constituent objects 305 by thickness, color, pattern or other attributes. Still further, the outline forms 312, 314, 316, 318 can include an outer line and an inner line, and the outer/inner lines can have different attributes of thickness, color, type or corner/end attributes. Further, as shown by examples of FIG. 3C and described below with other examples, the settings applied for the outline mode can provide for the outline forms 312, 314, 316, 318 to include attributes that are based on the boundary attributes of the combined shapes and the constituent objects, as rendered in the design mode.

FIG. 3D and FIG. 3E illustrate an example in which occluded objects are provided on a design interface that is rendered by rendering engine 120 being toggled between a default mode and an outline mode, according to one or more embodiments. In FIG. 3D, the design interface 320 is shown in default mode, where an object 322 is shown to include interior attributes. Further, the occlusion logic applied by the rendering engine 120 in the default mode provides for the object 322 to overlay and occlude another object 324. In the default mode, the overlaid object 324 may not be visible without further action on the part of the user. Additionally, the user may not be able to access or edit the occluded object without taking additional steps, such as steps to remove the object 322.

FIG. 3E illustrates the design interface 320 as rendered in the outline mode. In the outline mode, both of the objects 322, 324 are rendered as wireframes, such that both objects are viewable without occlusion. In examples, the overlaid object 324 is accessible to user input. Thus, for example, the user can manipulate the object 324 by changing its size, position or other attribute, without the user having to take additional action which would otherwise be needed in the default mode (e.g., the user temporarily separating the objects 322, 324 or selecting a specific layer to view the object 324 without the object 322).

FIG. 3F illustrates a variation of the design interface 320 as rendered in the outline mode. In a variation of FIG. 3E, bounding boxes 325, 327 of objects rendered on the design interface 320 is shown. Thus, in the outline mode, the bounding box 325 for the overlaid object 324 can be viewed by the user, along with the bounding box 327 for the object 322. The bounding box 325 provides information about the object 324, such as information that indicates the size of the object, the centerlines of the object or the alignment of the object with other objects or reference points. Further, the bounding box 325 can include features (e.g., handles) that the user can interact with in order to change an attribute (e.g., position, dimension) of the object.

FIG. 3G and FIG. 3H illustrate another example in which occluded objects are provided on a design interface 340 that is rendered by rendering engine 120 being toggled between a default mode and an outline mode, according to one or more embodiments. In FIG. 3G, the occlusive logic applied by rendering engine 120 includes clip logic, where a portion 346 of an object 345 that extends outside of the boundary 341 of another object 342 is hidden or invisible, while the portion 344 that is within the boundary of object 345 is visible.

FIG. 3H illustrates the design interface 340 as rendered in the outline mode. In the outline mode, an outline form of the objects 342, 345 are rendered without occlusion. Accordingly, the portion 346 of the partially occluded object 345 is rendered in outline form, along with outline forms of the portion 344 and object 342.

FIG. 3I and FIG. 3J illustrate an example design interface in respective default and outline modes, illustrating embodiments in which the attributes of the outline forms can be based on or correlative to boundary attributes of the respective objects in the default mode. In FIG. 3I, design interface 350 is rendered in the default mode, with objects 352, 354 having boundary and fill attributes. In examples, the boundary attributes for the objects 352, 354 include a respective exterior line 351, 357 and interior line 353, 359. Further, as shown, the respective exterior line 351, 357 and interior lines 353, 353 of corresponding objects 352, 354 can include different line attributes of thickness, color or line type. For example, the exterior lines 351, 357 of objects 352, 354 are significantly thicker than the corresponding interior lines 353, 359.

FIG. 3J illustrates the design interface 350 as rendered in the outline mode. In an example shown, the outline forms 362, 364 are rendered to include line and boundary attributes that are based online and boundary attributes of the corresponding objects 352, 354 as rendered in the default mode. For example, the outline form 362 includes exterior lines 361 and interior line 363, with the attribute of line thickness being greater for the exterior line 361 than for the interior line 363. Likewise, for the outline form 364, the exterior line 367 has a greater line thickness than the interior line 369. Further, as shown by an example of FIG. 3J, the line types of the exterior lines 361, 367 are solid, while the line type of the interior lines 363, 369 is dashed. The line types for the outline forms 362, 364 can be indicative of the line type or thickness of the boundary/line attributes of the corresponding objects 352, 354. In this way, the boundary/line attributes of the outline forms 362, 364 can be based on the boundary and line attributes of the objects 352, 354 as rendered in the default mode, in that the outline forms can include interior/exterior lines. Further, the attributes of the exterior lines 361, 367 and interior lines 363, 369 of the outline forms 362, 364 can be correlative to, or at least indicative of the boundary/line attributes of the corresponding objects 352, 354.

Further, in variations, other types of boundary/line attributes for objects rendered in the default mode can also be represented in the outline mode. For example, attributes that identify shaping of corners (e.g., rounded, tapered, etc.) can also be represented by the outline forms of the objects.

FIG. 3K illustrates additional functionality that can be implemented by an integrated graphic design system for use with an outline mode for the IGDS 100, according to one or more embodiments. For context and illustration, the default mode of the design mode can be rendered in accordance with other examples described elsewhere in this document, such as described and shown with FIG. 3A, FIG. 3D, FIG. 3G and FIG. 3I. Accordingly, in the default mode, some of the objects shown in FIG. 3K can be hidden in whole or in part.

With reference to FIG. 3K, design interface 360 is shown in outline mode to display a collection of objects, including container objects 370, 372 that each include a set of interior objects 373, 375. Additionally, a combined shape 368 is partially contained in the container object 370. In the default mode, only a portion of the combined shape 368 that is within the boundary of the container object is viewable. In the outline mode, the outline form of the combined shape 368 and/or constituent objects are visible. Further, a node tree representation 380 of the objects rendered on the design interface is shown, where nodes can identify relationships between objects. For example, the container object 370 can be represented by a node 371, having a subtree of nodes that includes all objects that are contained or partially contained within the container object 370

In examples, the container object 370 can be selected in order to highlight objects that are contained or partially contained within a boundary of the container object. As an addition or alternative, the container object 370 can be selected to highlight all of the objects that are represented by the node 371 and its subtree, where the nodes of the subtree correspond to nodes that are contained or partially contained within the container object 370. In such examples, the outline forms of the container node 370, the internal objects 373 and the combined shape 368 are visually distinguished (e.g., rendered in a different line color) from the outline forms of other objects, such as those of the container object 372.

Network Computer System

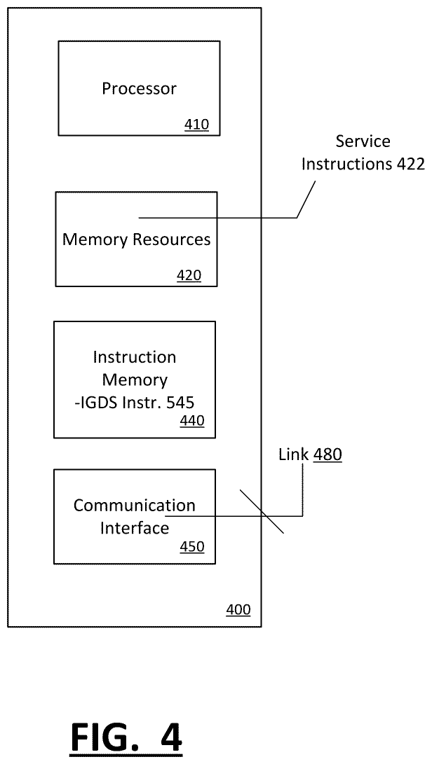

FIG. 4 illustrates a computer system on which one or more embodiments can be implemented. A computer system 400 can be implemented on, for example, a server or combination of servers. For example, the computer system 400 may be implemented as the network computing system 150 of FIG. 1A through FIG. 1C.

In one implementation, the computer system 400 includes processing resources 410, memory resources 420 (e.g., read-only memory (ROM) or random-access memory (RAM)), one or more instruction memory resources 440, and a communication interface 450. The computer system 400 includes at least one processor 410 for processing information stored with the memory resources 420, such as provided by a random-access memory (RAM) or other dynamic storage device, for storing information and instructions which are executable by the processor 410. The memory resources 420 may also be used to store temporary variables or other intermediate information during execution of instructions to be executed by the processor 410.

The communication interface 450 enables the computer system 400 to communicate with one or more user computing devices, over one or more networks (e.g., cellular network) through use of the network link 480 (wireless or a wire). Using the network link 480, the computer system 400 can communicate with one or more computing devices, specialized devices and modules, and/or one or more servers.

In examples, the processor 410 may execute service instructions 422, stored with the memory resources 420, in order to enable the network computing system to implement the network service 152 and operate as the network computing system 150 in examples such as described with FIG. 1A through FIG. 1C.

The computer system 400 may also include additional memory resources (“instruction memory 440”) for storing executable instruction sets (“IGDS instructions 444”) which are embedded with web-pages and other web resources, to enable user computing devices to implement functionality such as described with the IGDS 100.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium. Execution of the sequences of instructions contained in the memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

User Computing Device

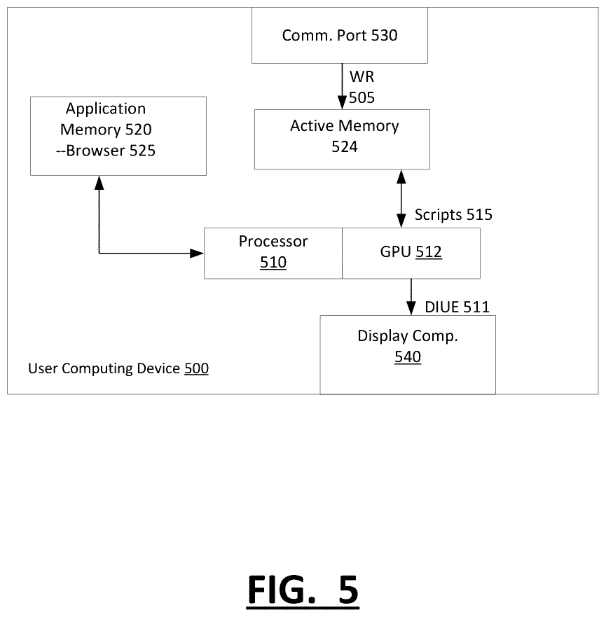

FIG. 5 illustrates a user computing device for use with one or more examples, as described. In examples, a user computing device 500 can correspond to, for example, a workstation, a desktop computer, a laptop or other computer system having graphics processing capabilities that are suitable for enabling renderings of design interfaces and graphic design work. In variations, the user computing device 500 can correspond to a mobile computing device, such as a smartphone, tablet computer, laptop computer, VR or AR headset device, and the like.

In examples, the computing device 500 includes a central or main processor 510, a graphics processing unit 512, memory resources 520, and one or more communication ports 530. The computing device 500 can use the main processor 510 and the memory resources 520 to store and launch a browser 525 or other web-based application. A user can operate the browser 525 to access a network site of the network service 152, using the communication port 530, where one or more web pages or other resources 505 for the network service 152 (see FIG. 1A through FIG. 1C) can be downloaded. The web resources 505 can be stored in the active memory 524 (cache).

As described by various examples, the processor 510 can detect and execute scripts and other logic which are embedded in the web resource in order to implement the IGDS 100 (see FIG. 1A through FIG. 1C). In some of the examples, some of the scripts 515 which are embedded with the web resources 505 can include GPU accelerated logic that is executed directly by the GPU 512. The main processor 510 and the GPU can combine to render a design interface under edit (“DIUE 511”) on a display component 540. The rendered design interface can include web content from the browser 525, as well as design interface content and functional elements generated by scripts and other logic embedded with the web resource 505. By including scripts 515 that are directly executable on the GPU 512, the logic embedded with the web resource 505 can better execute the IGDS 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
a memory sub-system to store a set of instructions;
one or more processors that operate to communicate the set of instructions to one or more user devices, wherein the set of instructions include instructions that when executed by each of the one or more user devices, cause the user device to perform operations that include:
implementing a rendering engine that is operable in at least a default mode and in an outline mode, wherein in the default mode, the rendering engine renders a design interface that includes multiple objects that partially intersect one another in position to form a combined shape; and
wherein in the outline mode, the rendering engine is operable to render an outline of each of the multiple objects and the combined shape.

2. The network computer system of claim 1, wherein the operations include:
enabling a user to select a logic type from multiple possible logic types to form the combined shape, the combined shape being based at least in part on the selected logic type; and
wherein in the outline mode, the outline of the combined shape is based at least in part on the selected logic type.

3. The network computer system of claim 1, wherein a line stroke for the outline of each of the multiple objects is different than a line stroke for the outline of the combined shape.

4. The network computer system of claim 1, wherein the multiple possible logic types include Boolean type combination logic.

5. The network computer system of claim 4, wherein the Boolean type combination logic includes union combination, intersection combination, subtraction combination, or exclude combination type logic.

6. The network computer system of claim 1, wherein in the outline mode, the rendering engine is operable to render the outline of each of the multiple objects without any of the multiple objects being occluded.

7. A non-transitory computer-readable medium that stores instructions, which when executed by a computer system, cause the computer system to perform operations that include:
implementing a rendering engine that is operable in at least a default mode and in an outline mode,
wherein in the default mode, the rendering engine is operable to render a design interface that includes multiple objects, and to apply occlusive logic to (i) occlude at least a portion of an object that intersects another object, and (ii) preclude a type of user interaction with the portion of the object that is occluded; and
wherein in the outline mode, the rendering engine is operable to render an outline of each of the multiple objects without occlusion, and to enable the type of user interaction with the portion of the object that is occluded in the default mode.

8. The non-transitory computer-readable medium of claim 7, wherein in the outline mode, the rendering engine is operable to render a bounding box for objects that are occluded by an occlusion logic.

9. The non-transitory computer-readable medium of claim 8, wherein in the outline mode, the rendering engine is operable to enable a user to interact with the bounding box of an object of the multiple objects that is occluded by the occlusion logic.

10. The non-transitory computer-readable medium of claim 7, wherein the instructions are received from a network computer system.

11. A computer-implemented method comprising:
rendering a design interface in a default mode, the design interface including multiple objects that at least partially intersect one another, and wherein rendering the design interface the in the default mode includes occluding at least a portion of one or more of the multiple objects in accordance with at least a first occlusive logic;
responsive to user input, rendering the design interface in an outline mode by rendering at least a portion of each of the multiple objects without occlusion.

12. The computer-implemented method of claim 11, wherein rendering the design interface in the outline mode includes rendering a wireframe of the multiple objects.

13. The computer-implemented method of claim 12, wherein rendering at least a portion of the wireframe of each of the multiple objects without rendering any fill characteristic of any of the multiple objects.

14. The computer-implemented method of claim 11,
wherein in the default mode, the method further comprises precluding a type of user interaction with the portion of the one or more objects that are occluded; and
wherein in the outline mode, the method further comprises enabling the type of user interaction with the portion of the one or more objects that is occluded in the default mode.

15. The computer-implemented method of claim 11, wherein in the default mode, the method further comprises: applying multiple types of occlusive logic to occlude at least the portion of one or more of the multiple objects.

16. The computer-implemented method of claim 11, wherein applying the first occlusive logic includes applying object combination logic, wherein the object combination logic forms a combined shape from two or more objects by at least partially occluding at least one of the two or more objects.

17. The network computer system of claim 16, wherein the occlusive logic includes logic in which one object overlays another object.

18. The computer-implemented method of claim 11, wherein the method further comprises:
enabling a user to select a logic type from multiple possible logic types to form the combined shape, the combined shape being based at least in part on the selected logic type; and
wherein in the outline mode, the outline of the combined shape is based at least in part on the selected logic type.

19. The computer-implemented method of claim 18, wherein the multiple possible logic types include Boolean type combination logic, including one or more of union combination logic, intersection combination logic, subtraction combination logic, or exclude combination type logic.

20. The computer-implemented method of claim 11, wherein a line stroke for the outline of each of the multiple objects is different than a line stroke for the outline of the combined shape.
